(19) United States
(12) Patent Application Publication
(10) Pub. No.: US 2012/0257022 A1
(43) Pub. Date: Oct. 11, 2012

(54) IMAGING APPARATUS AND IMAGING METHOD

(76) Inventors: Hidekazu SUTO, Tokyo (JP); Masamiki Kawase, Tokyo (JP); Fumio Sekiya, Tokyo (JP)

(21) Appl. No.: 13/435,192

(22) Filed: Mar. 30, 2012

(30) Foreign Application Priority Data
Apr. 7, 2011 (JP) 2011-085628

(51) Int. Cl. H04N 13/02

(52) U.S. Cl. 348/47; 348/E13.074; 348/E13.014; 348/E13.025

(57) ABSTRACT

An imaging apparatus includes: an imaging section converting image light impinging thereon through a lens device into an electrical imaging signal; an imaging process section processing the imaging signal output by the imaging section; an output section converting the imaging signal processed by the imaging process section into an image signal in a predetermined format and outputting the image signal; a terminal for synchronization for connection with another imaging apparatus; and an imaging control section controlling imaging at timing in synchronism with the other imaging apparatus and putting the lens device in the same state of control as the state of control of the other imaging apparatus when the communication with the other imaging apparatus can be performed through the terminal section for synchronization.

### FIELD

The present disclosure relates to an imaging apparatus and an imaging method and, more particularly, to a technique to be used for three-dimensional imaging (3D imaging).

### BACKGROUND

When a three-dimensional image is to be obtained using imaging apparatus such as video cameras, two imaging apparatus are prepared. Imaging is performed by each of the imaging apparatus separately to obtain an image for a left channel and an image for a right channel. In this case, the two imaging apparatus are secured together using a connecting mechanism referred to as “rig”, and imaging is performed with the optical axes of lens devices mounted to the imaging apparatus kept in parallel with each other.

When three-dimensional imaging is performed using two imaging apparatus as thus described, each of the imaging apparatus must be operated and adjusted separately. For example, lens focusing and zooming necessitates adjusting operations performed on each of the imaging apparatus. Focusing and zooming must be adjusted in full harmony between the two imaging apparatus.

JP-A-4-323672 (Patent Document 1) has disclosed a lens device to be mounted to an imaging apparatus for three-dimensional imaging. The lens device is formed by linking a lens section for a left channel and a lens section for a right channel into one unit to allow the lens sections for both channels to be focused in conjunction with each other.

### SUMMARY

In the case of imaging apparatus intended for three-dimensional imaging from the design phase of development such as the apparatus disclosed in patent Document 1, it is relatively easy to provide a mechanism for allowing lens sections for left and right channels to operate in conjunction with each other. On the contrary, when three-dimensional imaging is performed using two ordinary imaging apparatus which are not intended for three-dimensional imaging', it is practically difficult to use a linking mechanism as described above. Therefore, when two imaging apparatus are secured together with a rig or the like to perform three-dimensional imaging, the lens of each apparatus is adjusted, and it is thereafter checked whether the two imaging apparatus are matched with each other in terms of their states after the adjustment. When there is any mismatch between the adjusted states of the apparatus, the lenses of the apparatus must be readjusted. There has been a problem in that three-dimensional imaging can be very much bothersome in such a situation.

While the description has focused on a problem associated with lens adjustment, the problem of bothersome adjustment also occurs in signal processing systems of two imaging apparatus in that adjustment of such systems must be carried out at the two apparatus in the same way as the lens adjustment.

It is therefore desirable to facilitate operations and adjustment required when three-dimensional imaging is performed using two imaging apparatus.

According to an embodiment of the present disclosure, a first imaging apparatus and a second imaging apparatus are connected such that the apparatuses communicate with each other. The first imaging apparatus and the second imaging apparatus perform imaging at synchronous timing. A setting for a lens device mounted to the first imaging apparatus is determined by a control section provided in the first imaging apparatus, and the setting for the lens device thus determined is transmitted to the second imaging apparatus. At the second imaging apparatus, a setting for a lens device mounted to the second imaging apparatus is made based on the lens device setting thus received according to an instruction from a control section in the second imaging apparatus.

Through the processes as thus described, when a change is made to the setting for the lens device mounted to the first imaging apparatus as a result of an operation by an operator, the setting change is determined in the first imaging apparatus, and information on the setting change is transmitted to the second imaging apparatus. Upon receipt of the information on the setting change, the second imaging apparatus performs a process of changing the setting for the lens device amounted to the second imaging apparatus in the same way as in the first imaging apparatus based on the received information on the setting change.

According to the embodiment of the present disclosure, when a setting for a lens device mounted to one of two imaging apparatus connected with each other is changed by a manual operation or the like, a setting for a lens device mounted to the other imaging apparatus is also changed in conjunction with the change. Therefore, it is not required to perform adjustment for matching lens settings of the two imaging apparatus in terms of focusing, zooming, and the like. Thus, adjustment of two imaging apparatus for obtaining a three-dimensional image can be significantly facilitated.

### BRIEF DESCRIPTION OF THE DRAWINGS

FIG. 1 is a diagram showing a configuration of imaging apparatus according to an embodiment of the present disclosure;

FIG. 2 is an illustration showing an exemplary correction process according to the embodiment of the present disclosure;

FIG. 3 is an illustration showing exemplary data transmission according to the embodiment of the present disclosure;

FIG. 4 is a flow chart showing synchronous processes according to the embodiment of the present disclosure; and

FIG. 5 is a flow chart showing processes performed in response to an instruction from a remote controller according to the embodiment of the present disclosure.

### DETAILED DESCRIPTION

An embodiment of the present disclosure will now be described according to the following list of items.

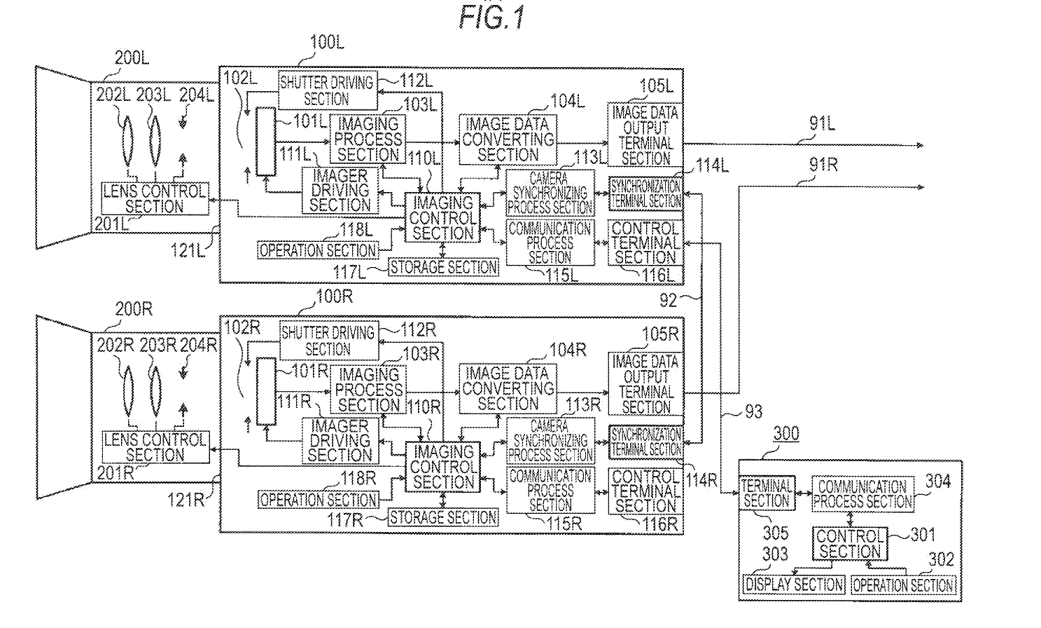

1. Configurations of System as a Whole and Imaging Apparatus (FIG. 1)

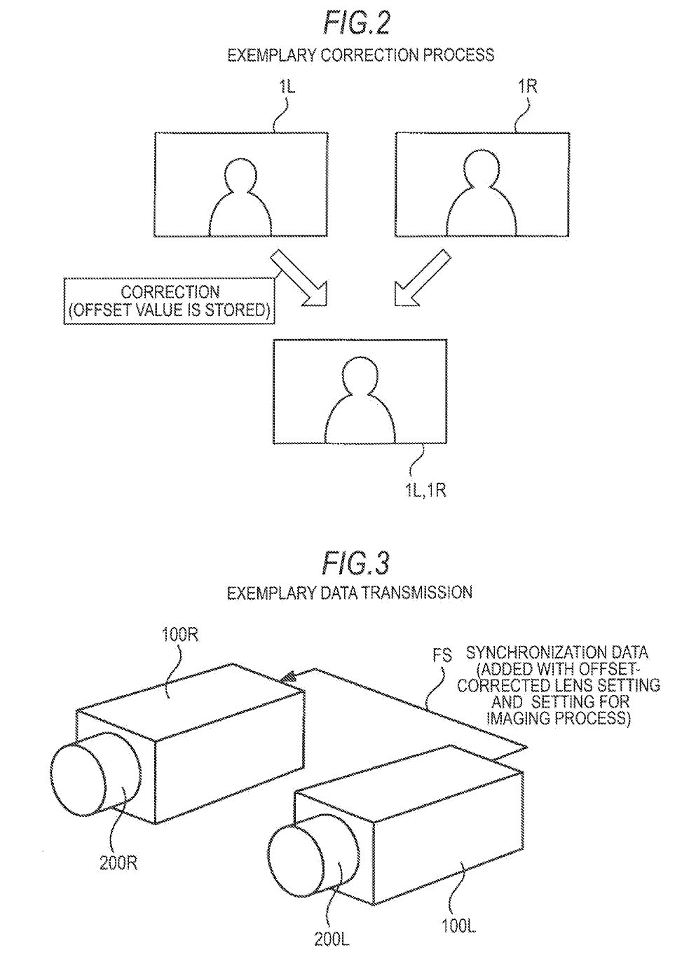

2. Data Transmission between Imaging Apparatus (FIGS. 2 and 3)

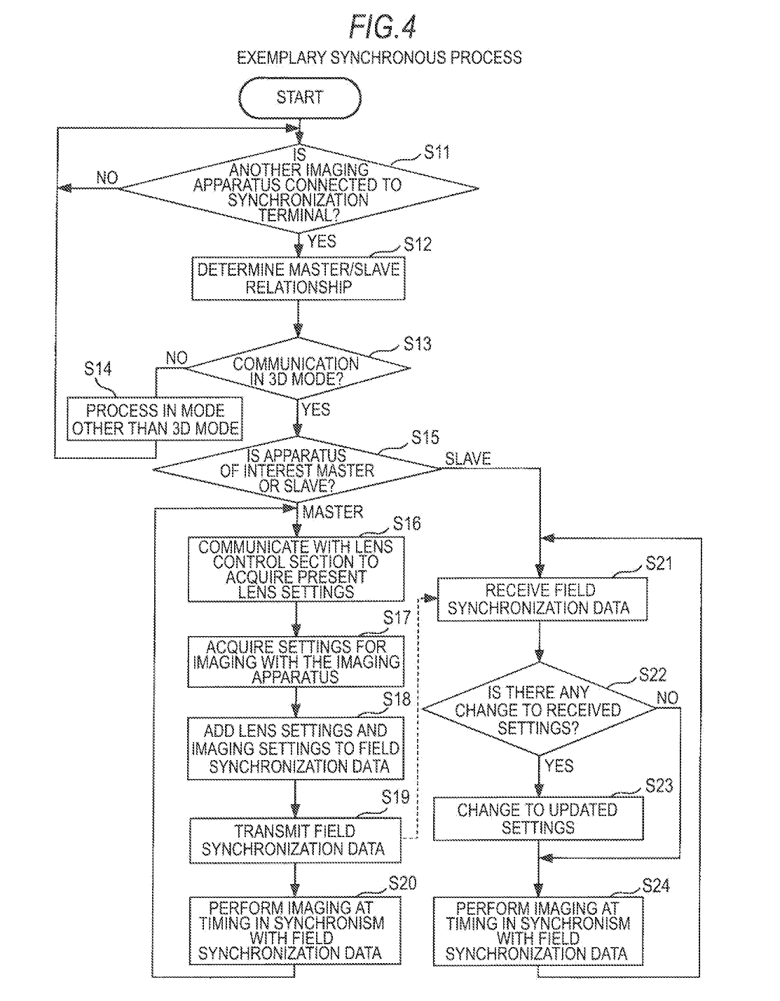

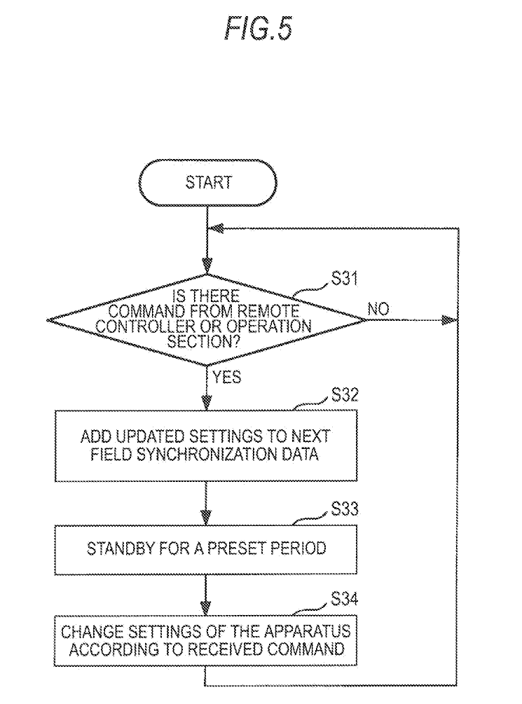

3. Synchronous Processes between Two Imaging Apparatus (FIG. 4)

4. Processes in Response to Instruction from Remote Controller (FIG. 5)

5. Modifications

### [1. Configurations of System as a Whole and Imaging Apparatus]

Configurations of a system as a whole and imaging apparatus according to an embodiment of the present disclosure will now be described with reference to FIG. 1.

An imaging system according to the present embodiment is a system for performing three-dimensional imaging using two imaging apparatus 100L and 100R. Specifically, an image for a left channel is obtained by the imaging apparatus 100L (first imaging apparatus), and an image for a right channel is obtained by the imaging apparatus 100R (second imaging apparatus).

The two imaging apparatus 100L and 100R are secured together using a linking mechanism such as a rig (not shown) to allow imaging to be performed with optical axes of lens devices 200L and 200R mounted to the imaging apparatus 100L and 100R respectively kept in parallel with each other.

The first imaging apparatus 100L and the second imaging apparatus 100R are imaging apparatus which are identical in configuration. A normal image which is not stereoscopic (a 2D image) can be obtained using either the imaging apparatus 100L or 100R alone. Referring to FIG. 1, a character “L” is added to reference numerals representing elements forming the first imaging apparatus 100L for the left channel, and a character “R” is added to reference numerals representing elements forming the second imaging apparatus 100R for the right channel. The characters “L” and “R” are added to indicate association between the elements and left and right channels of an image signal, and the characters do not indicate any difference in configuration between the imaging apparatus. The characters “L” and “R” are also added to reference numerals representing elements of the lens devices 200L and 200R mounted to the imaging apparatus 100L and 100R for the same purpose.

Since the first imaging apparatus 100L and the second imaging apparatus 100R are identical in configuration, only a configuration of the first imaging apparatus 100L will be described below as a configuration of the imaging apparatus.

The first imaging apparatus 100L includes an imager 101L serving as an imaging section. The imager 101L converts image light impinging thereon through the lens device 200L into an electrical imaging signal. The lens device 200L is mounted to a mount section 121L of the imaging apparatus 100L.

The timing of an imaging operation of the imager 101L is determined by a driving pulse supplied from an imager driving section 111L. A shutter 102L is disposed in front of a light receiving surface of the imager 101L, and the shutter 102L is opened and closed in conjunction with the imaging operation of the imager 101L. The shutter 102L is opened and closed at timing which is determined by a driving signal supplied from a shutter driving section 112L. The imaging apparatus may be configured as a shutterless apparatus by employing an imager 101L which is constituted by an imaging element requiring no shutter.

An imaging signal output by the imager 101L is supplied to an imaging process section 103L, and the imaging process section 103L performs various imaging processes. For example, the imaging process section 103L performs processes such as gain adjustment, white balance adjustment, and gamma correction.

An imaging signal output by the imaging process section 103L is supplied to an image data converting section 104L. The image data converting section 104L performs an image data outputting process for converting an imaging signal supplied to the section into image data in a predetermined format to be output. The image data obtained by conversion at the image data converting section 104L is supplied to an image data output terminal section 105L. Thus, the image data converting section 104L and the image data output terminal section 105L serve as sections for outputting image data.

Image data for a left channel is supplied to an eternal apparatus using an image data output line 91L which is connected to the image data output terminal section 105L. Image data for left and right channels output from the imaging apparatus 100L and 100R is supplied to an external editing apparatus or recording apparatus which is not shown, and the data is thereby edited or recorded.

The imaging process at the imaging process section 103L and the conversion process at the image data converting section 104L are performed under control exercised by an imaging control section 110L. A storage section 117L is connected to the imaging control section 110L, and data required for control is stored in the storage section 117L under control exercised by the imaging control section 110L. Data of a lens offset amount which will be described later is also stored in the storage section 117L.

The imaging apparatus 100L includes an operation section. 118L including operation keys to be operated by a user. The imaging control section 110L sets imaging conditions based on operation data supplied from the operation section 118L. For example, various adjustments carried out by the imaging process section 103L and the format used for the conversion at the image data converting section 104L are set by operations performed by a user.

In addition to operation keys for instructing imaging conditions to be set in the body of the imaging apparatus, the operation section 118L includes operation keys for instructing states of lenses to be set. For example, the section includes a key for a zooming operation, a key for focus adjustment, and a key for iris adjustment. When operation data generated based on a key operation for setting a lens state is supplied from the operation section 118L to the imaging process section 103L, an instruction in accordance with the operation data is transmitted from the imaging process section 103L to the lens device 200L. The configuration of the lens device 200L will be described later.

The imaging apparatus 100L includes a synchronization terminal section 114L and a control terminal section 116L as terminals for communication with other apparatus. The synchronization terminal section 114L is a terminal for performing imaging in synchronism with another imaging apparatus. In the example shown in FIG. 1, the second imaging apparatus 100R is connected to the synchronization terminal section 114L through a camera connecting line 92. A communication process utilizing the synchronization terminal section 114L is performed by a synchronization process section 113L under control exercised by the imaging control section 110L. In the present embodiment, field synchronization data (or frame synchronization data) determining a field period (or a frame period) at which imaging is to be performed is transmitted from the synchronization terminal section 114L.

The control terminal section 116L is a terminal for connecting a remote controller 300. In order to communicate with the remote controller 300, the imaging apparatus 100L has a communication process section 115L, and the communication control section 115L performs a process of determining a command included in a signal received at the control terminal section 116L. The imaging control section 110L exercises operation control based on the command determined by the communication process section 115L. When the imaging apparatus is connected to the other imaging apparatus 100R through the synchronization terminal section 114L, the command determined by the communication process section 115L is added to the field synchronization data (or frame synchronization data) transmitted from the synchronization terminal section 114L.

Since the first imaging apparatus 100L and the second imaging apparatus 100R are identical in configuration, the apparatus have their respective control terminals 116L and 116R. In the present embodiment, the remote controller 300 is only required to be connected to the control terminal section of either imaging apparatus, and nothing is connected to the control terminal section of the other imaging apparatus.

The remote controller 300 is a control device which allows a user to give instructions to start and stop imaging, instructions to set lens state such as zooming and focusing, and instructions to make various settings of the imaging apparatus. The remote controller is connected to the control terminal section 116L through a remote control line 93.

Let us describe a configuration of the remote controller 300. An operation section 302 and a display section 303 are connected to a control section 301, and commands are generated by the control section 301 based on operations performed on the operation section 302. The commands thus generated are sent to a communication process section 304 and converted by the communication process section 304 into modulated data to be transmitted. The modulated data to be transmitted is output from a terminal section 305 to a remote control line 93. The state of transmission of an operational command or the like is displayed on the display section 303.

When the remote controller 300 and the imaging apparatus 100L communicate on a bi-directional basis, the remote controller 300 may receive information on the state of operation of the imaging apparatus 100L and may display the state of operation thus received on the display section 303. The system configuration including the remote controller 300 is merely an example, and imaging may be performed without the remote controller 300.

A configuration of the lens device 200L mounted to the mount section 121L of the imaging apparatus 100L will now be described.

The lens device 200L includes a focus lens 202L, a zoom lens 203L, and an iris 204L. The focus lens 202L, the zoom lens 203L, and the iris 204L are accompanied by respective driving portions (not shown) for setting the positions of the lenses and iris according to commands from a lens control section 201L of the lens device 200L. Sensors (not shown) for detecting the position of the focus lens 202L (focus setting position), the position of the zoom lens 203L (zoom setting position), and the position of the iris 204L (iris setting position) are provided, and the output of each sensor is supplied to the lens control section 201L. The lens control section 201L determines the current focus lens position, zoom lens position, and iris position. The data of the current focus lens position, zoom lens position, and iris position thus determined is supplied to the imaging control section 110L of the imaging apparatus 100L.

The lens control section 201L and the imaging control section 110L are connected such that they can communicate through a contact provided at the mount section 121L, and those sections periodically communicate at the frame period or the like. Commands are sent from the imaging control section 110L using the periodic communication to instruct the lens control section 201L to change the focus lens position, the zoom lens position, and the iris position. Data representing the actual focus lens position, zoom lens position, and iris position detected by the sensors is sent from the lens control section 201L to the imaging control section 110L.

### [2. Example of Data Transmission Between Imaging Apparatus]

An example of data transmission between the first imaging apparatus 100L and the second imaging apparatus 100R will now be described with reference to FIGS. 2 and 3.

First, a process of measuring the offset amounts between lens characteristics of the lens devices 200L and 200R mounted to the two imaging apparatus 100L and 1008 respectively is performed as an initial setup. For example, the process of measuring offset amounts between lens characteristics is performed using an editing apparatus to which image data output from the two imaging apparatus 100L and 100R is input and a monitor which is connected to the editing apparatus. For example, commands may be sent to the lens devices 200L and 200R to set a focus lens position, a zoom lens position, and an iris position which are the same between the lens devices, and images output from the imaging apparatus 100L and 100R in such a setting are displayed on a monitor.

For example, a left channel image 1L and a right channel image 1R may be alternately displayed, or may be displayed side-by-side on the screen, as shown in FIG. 2. The images 1L and 1R are compared to determine the amount of an offset between the zoom lens positions of the two lens devices from a difference between the sizes of the displayed images. The amount of an offset between the focus lens positions and the amount of an offset between the iris positions are also determined from the states of display of the images. A user may determine those amounts from the state of display of the monitor, or may determine them automatically by measuring various characteristics of the images.

Each of the offset values thus determined is stored in the storage section 117L of the imaging apparatus 100L. Such a storing operation may be automatically performed by supplying adjustment data to the imaging apparatus 100L from outside. Alternatively, the values of offset amounts may be manually set by a user using the operation section 118L.

As shown in FIG. 3, when data of lens positions is sent from the first imaging apparatus 100L to the second imaging apparatus 100R after the offset amount data is set, the offset amounts stored in the storage section 117L are read out to obtain data of positions to be set which are shifted from the lens positions of the apparatus 100L by the offset amounts.

As shown in FIG. 3, the data of lens positions to be set is supplied from the first imaging apparatus 100L to the second imaging apparatus 100R in addition to field synchronization data FS (or frame synchronization data). Data of settings for the imaging process is also supplied in addition to the field synchronization data FS. The data associated with the imaging process also includes shutter speed data.

The data of settings for the imaging process may be offset values which are set based on differences in characteristics measured between the two imaging apparatus 100L and 100R. While data of offset amounts is sent from the first imaging apparatus 100L to the second imaging apparatus 100R in the example shown in FIG. 3, the first imaging apparatus 100L itself may correct the offset by sending a command instructing shifts equivalent to the offset amounts to the lens device 200L.

### [3. Synchronous Processes Between Two Imaging Apparatus]

Exemplary synchronous processes performed by the imaging apparatus 100L and 100R will now be described with reference to the flow chart in FIG. 4. The flow chart in FIG. 4 shows a determination process performed under control exercised by the imaging control sections 110L and 110R of the imaging apparatus 100L and 100R, respectively.

It is determined whether the apparatus are connected to each other through the synchronization terminal sections 114L and 114R (step S11). When it is determined that the imaging apparatus are not connected to each other, no synchronous process is performed.

When it is determined at step S11 that the imaging apparatus are connected to each other, either of the two imaging apparatus is elected to be a master, and the other apparatus is elected to be a slave (step S12). For example, when the remote controller 300 is connected as shown in FIG. 1, the imaging apparatus 100L and imaging apparatus 1008 are elected to be a master and a slave, respectively, at the master-slave election process. When the remote controller 300 is not connected, either of the apparatus may be elected as a master. The imaging apparatus elected to be a slave (e.g., the imaging apparatus 100R) invalidates operations performed on the operation section of the imaging apparatus.

After a master and a slave are elected as thus described, it is determined whether the communication mode to be used for synchronous processes is a 3D mode that is a mode for three-dimensional imaging (step S13). When the communication mode is a mode other than the 3D mode, the flow proceeds to step S14 to perform an imaging process in the mode which is presently set.

When it is determined at step S13 that the communication mode is the 3D mode, each apparatus determines whether it is set to serve as a master or to serve as a slave (step S15). When it is determined that the apparatus is set to serve as a master, the imaging control section communicates with the lens control section mounted to the apparatus to acquire values representing the present lens positions (step S16). The present lens positions are the actual positions of the lenses measured by a sensor attached to the lens device. The imaging control section acquires values representing settings for image processing at the imaging process section of the imaging apparatus (step S17). The values of lens positions and the values representing settings for imaging processing are added to field synchronization data to be transmitted to the other imaging apparatus (step S18). These values are shifted by offset amounts as described above, and resultant values are added as a command including such values to be set.

The field synchronization data added with the command including the values to be set is transmitted to the other imaging apparatus (step S19). Thereafter, the imaging apparatus performs image processing of one field at timing in synchronism with the field synchronization data transmitted as thus described (step S20). When the image processing of one field is completed, the flow returns to the process at step S16 to repeat the series of processes performed at steps 16 to S20, one field being processed by each series of processes.

The imaging apparatus which has identified itself as a slave at step S15 performs a process of receiving field synchronization data transmitted from the other imaging apparatus (step S21). The field synchronization data is the data which has been transmitted from the imaging apparatus serving as a master at step S19.

When the field synchronization data is received at step S21; the values of lens position to be set and the values of settings for image processing added to the received field synchronization data are determined, and it is determined whether any change has been made to settings instructed when the preceding field synchronization data was received (step S22). If it is determined that changes have been made, instructions are sent from the imaging control section to the lens control section of the lens device connected to the imaging apparatus and to the imaging process portion of the imaging apparatus such that settings will be made to reflect the updated values (step S23). When it is determined at step S22 that there is no change, the process at step S23 is not performed. Thereafter, the imaging apparatus performs image processing of one field at timing in synchronism with the field synchronization data received at step S21 (step S24). When the image processing of one field is completed, the flow returns to the process at step S16 to repeat the series of processes performed at steps 21 to S24, one field being processed by each series of processes.

The two imaging apparatus 100L and 100R perform imaging in synchronism with each other by performing the processes shown in the flow chart of FIG. 4. When any change in lens settings is made by a user's operation on the operation section 118L of the imaging apparatus serving as a master (the imaging apparatus 100L in this case), data of updated lens positions to be set based on the operation is sent to the imaging apparatus 100R serving as a slave. Thus, control is exercised to set the apparatus in the same state. The lens positions to be set are instructed after adding offset amounts measured in advance, which allows the two imaging apparatus to perform imaging in full harmony between them. The data of lens positions to be set sent to the imaging apparatus 100R serving as a slave reflects the actual lens position detected by a sensor. Therefore, the imaging can be performed in full harmony without any mismatch between the imaging apparatus.

The imaging apparatus 100L serving as a master instructs the imaging apparatus 100R serving as a slave also on settings for imaging such as shutter speed and settings for gain adjustment and white balance adjustment performed by the imaging process section. Therefore, imaging can be performed in full harmony between the apparatus also in terms of settings for image processing.

Since synchronous processes between the imaging apparatus 100L and 100R are performed only when they are connected through the camera connecting line 92, each apparatus may be used alone to perform normal imaging which is not intended for three-dimensional viewing. Therefore, the system has high versatility.

The processes shown in the flow chart of FIG. 4 are on an assumption that the data of lens positions to be set transmitted from the imaging apparatus 100L serving as a master to the imaging apparatus 100R serving as a slave is data reflecting actual positions of the lenses of the lens device 200L detected by a sensor provided in the device. Alternatively, values to be set specified by the imaging control section 110L of the imaging apparatus 100L may be sent to the imaging apparatus 100R serving as a slave. In this case, the values to be set may be values which are shifted from the actual lens positions by amounts equivalent to offset amounts.

[4. Processes in Response to Instruction from Remote Controller]

The processes in the flow chart shown in FIG. 4 have been described without paying consideration to any mismatch between the two imaging apparatus 100L and 100R in terms of timing of lens position setting. The two apparatus may be synchronized also in timing at which their lenses are moved. Specifically, data is transmitted from one imaging apparatus to another, which results in a delay equivalent to the time required for the process of transmitting and receiving the data. The operation of the imaging apparatus can be synchronized by correcting such a delay.

The flow chart shown in FIG. 5 shows one exemplary mode for synchronizing the operation of the imaging apparatus. The imaging apparatus to serve as a master determines whether a command associated with lens settings has been received from the remote controller or whether an operation associated with lens settings has been performed on the operation section (step S31). When it is determined that a command or operation associated with lens settings has been input, the updated values to be set are added to field synchronization data to be transmitted to the imaging apparatus serving as a slave (step S32). Thereafter, the imaging apparatus serving as a master stays in a standby state for a preset period (step S33). The standby period at step S33 is a period for correcting timing to achieve synchronization. After the standby period, the imaging apparatus starts a process of changing its lens settings according to the command or operation (step S34).

When it is determined at step S31 that no command or operation associated with lens settings has been input or when the process at step S34 is started, the flow returns to the determination at step S31.

The processes shown in the flow chart of FIG. 5 allow lens settings to be changed at the same timing between the two imaging apparatus, and three-dimensional imaging can therefore be more satisfactorily performed. For example, when the processes are applied to control over zoom lenses, images of the left and right channels are zoomed in synchronism with each other, and a resultant three-dimensional image will be a satisfactory image which does not cause a feeling of unnaturalness.

### [5. Modifications]

The embodiment shown in FIG. 1 has a configuration in which keys for focusing and zooming a lens device and operating the iris of the device are provided on the body of the imaging apparatus associated with the lens device. Alternatively, the focusing and zooming keys and the iris operating key may be provided on the lens device. Still alternatively, the lens device may include a focus ring and a zoom ring which can be manually operated by a user. Data representing lens positions changed by manually operating the rings may be transmitted to the imaging apparatus.

The embodiment shown in FIG. 1 has a configuration in which amounting section is provided on the body of an imaging apparatus to allow a lens device to be mounted and removed to and from the apparatus. Alternatively, a lens device may be configured to be fixedly mounted on an imaging apparatus.

The processes shown in the flow chart of FIG. 5 include a process of keeping the first imaging apparatus 100L in a standby state upon receipt of an instruction from a remote controller (the process at step S33) for a period required for the second imaging apparatus 100R to start operating. Alternatively, when an instruction for an operation is given, timing to start the operation (or timing at which setting is to be completed) may be also instructed to the second imaging apparatus 100R to cause the imaging apparatus 100L and 100R to start operating simultaneously at the timing instructed.

The present disclosure may be implemented as the following configurations.

(1) An imaging apparatus including:

an imaging section converting image light impinging thereon through a lens device into an electrical imaging signal;

an imaging process section processing the imaging signal output by the imaging section;

an output section converting the imaging signal processed by the imaging process section into an image signal in a predetermined format and outputting the image signal;

a terminal for synchronization for connection with another imaging apparatus; and

an imaging control section controlling imaging at timing in synchronism with the other imaging apparatus and putting the lens device in the same state of control as the state of control of the other imaging apparatus when the communication with the other imaging apparatus can be performed through the terminal section for synchronization.

(2) The imaging apparatus according to the item (1), which further include a storage section for storing information for correcting a difference between characteristics of the lens device mounted to the imaging apparatus and characteristics of a lens device mounted to the other imaging apparatus.

(3) The imaging apparatus according to the item (1) or (2), wherein the imaging control section performs a process of communicating with a lens control section of the lens device mounted to the imaging apparatus and communicating with the other imaging apparatus through the terminal section for synchronization to notify the other imaging apparatus of a lens setting value obtained as a result of the communication with the lens control section.

(4) The imaging apparatus according to any of the items (1), (2), and (3), wherein the imaging control section also performs a process of notifying the other imaging apparatus of a setting for the imaging process section using the communication through the terminal section for synchronization.

(5) The imaging apparatus according to the items (1), (2), (3) and (4), wherein the imaging control section performs a process of

transmitting a frame synchronization signal or a field synchronization signal to the other imaging apparatus connected through the terminal section for synchronization at a frame period or a field period, and

adding a value at which the lens is set and a setting for the imaging process section to the frame synchronization signal or the field synchronization signal.

(6) The imaging apparatus according to any of the items (1), (2), (3), (4) and (5), wherein the state to be controlled of the lens device is a value to be set instructed from an external controller, the apparatus performing a process of transmitting the value to be set instructed from the external controller to the lens control section of the lens device mounted to the imaging apparatus and notifying the other imaging apparatus connected through the terminal section for synchronization of the value to be set.

(7) The imaging apparatus according to any of the items (1), (2), (3), (4), (5) and (6), wherein the imaging control section communicates with the other imaging apparatus connected through the terminal section for synchronization and performs a process of notifying the lens control section of the lens device mounted to the imaging apparatus of a lens setting value obtained through the communication.

(8) The imaging apparatus according to the item (7), wherein the imaging control section communicates with the other imaging apparatus connected through the terminal section for synchronization and performs a process of also acquiring information on a setting for an imaging process and making the setting for an imaging process thus acquired in the imaging process section.

The present disclosure contains subject matter related to that disclosed in Japanese Priority Patent Application JP 2011-085628 filed in the Japan Patent Office on Apr. 7, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging section converting image light impinging thereon through a lens device into an electrical imaging signal;
an imaging process section processing the imaging signal output by the imaging section;
an output section converting the imaging signal processed by the imaging process section into an image signal in a predetermined format and outputting the image signal;
a terminal for synchronization for connection with another imaging apparatus; and
an imaging control section controlling imaging at timing in synchronism with the other imaging apparatus and putting the lens device in the same state of control as the state of control of the other imaging apparatus when the communication with the other imaging apparatus can be performed through the terminal section for synchronization.

2. The imaging apparatus according to claim 1, comprising a storage section for storing information for correcting a difference between characteristics of the lens device mounted to the imaging apparatus and characteristics of a lens device mounted to the other imaging apparatus.

3. The imaging apparatus according to claim 2, wherein the imaging control section performs a process of communicating with a lens control section of the lens device mounted to the imaging apparatus and communicating with the other imaging apparatus through the terminal section for synchronization to notify the other imaging apparatus of a lens setting value obtained as a result of the communication with the lens control section.

4. The imaging apparatus according to claim 3, wherein the imaging control section also performs a process of notifying the other imaging apparatus of a setting for the imaging process section using the communication through the terminal section for synchronization.

5. The imaging apparatus according to claim 4, wherein the imaging control section performs a process of
transmitting a frame synchronization signal or a field synchronization signal to the other imaging apparatus connected through the terminal section for synchronization at a frame period or a field period, and
adding a value at which the lens is set and a setting for the imaging process section to the frame synchronization signal or the field synchronization signal.

6. The imaging apparatus according to claim 5, wherein the state to be controlled of the lens device is a value to be set instructed from an external controller, the apparatus performing a process of transmitting the value to be set instructed from the external controller to the lens control section of the lens device mounted to the imaging apparatus and notifying the other imaging apparatus connected through the terminal section for synchronization of the value to be set.

7. The imaging apparatus according to claim 2, wherein the imaging control section communicates with the other imaging apparatus connected through the terminal section for synchronization and performs a process of notifying the lens control section of the lens device mounted to the imaging apparatus of a lens setting value obtained through the communication.

8. The imaging apparatus according to claim 7, wherein the imaging control section communicates with the other imaging apparatus connected through the terminal section for synchronization and performs a process of also acquiring information on a setting for an imaging process and making the setting for an imaging process thus acquired in the imaging process section.

9. An imaging method comprising:
connecting a first imaging apparatus and a second imaging apparatus such that the apparatus communicate with each other;
performing imaging with the first imaging apparatus and the second imaging apparatus at synchronous timing;
determining a setting for a lens device mounted to the first imaging apparatus with a control section provided in the first imaging apparatus and transmitting the setting for the lens device thus determined to the second imaging apparatus; and
using the setting for the lens device received by the second imaging apparatus as a setting for a lens device mounted to the second imaging apparatus according to an instruction from a control section provided in the second imaging apparatus.
